(19) United States
(12) Patent Application Publication
(10) Pub. No.: US 2026/0313625 A1
(43) Pub. Date: Oct. 8, 2026

(54) WIRELESS COMMUNICATIONS

(71) Applicant: IRIDIUM SATELLITE LLC, McLean, VA (US)

(72) Inventor: Charles H. WOLOSZYNSKI, Charlottesville, VA (US)

(73) Assignee: IRIDIUM SATELLITE LLC, McLean, VA (US)

(21) Appl. No.: 19/637,957

(22) Filed: Apr. 2, 2026

Related U.S. Application Data
(60) Provisional application No. 63/783,709, filed on Apr. 4, 2025.

(51) Int. Cl. H04W 72/0453

(52) U.S. Cl. CPC H04W 72/0453

(57) ABSTRACT

In one implementation, wireless communications are enabled between user equipment and a communications payload in an unpaired frequency band using a protocol that employs defined system frames. The user equipment determines an uplink periodicity—that may be expressible as a ratio of 1/N (where N represents a number of system frames)—at which the communications payload expects to receive uplink transmissions in the unpaired frequency band from the user equipment and transmits uplink transmissions in the unpaired frequency band to the communications payload at the determined uplink periodicity.

### CROSS-REFERENCE TO RELATED APPLICATION

This application claims the benefit of U.S. Provisional Patent Application No. 63/783,709 filed on Apr. 4, 2025, the disclosure of which is incorporated herein by reference in its entirety.

### TECHNICAL FIELD

This disclosure relates generally to wireless communications, and, more specifically, to wireless communications that may be referred to as Narrowband Internet of Things (“NB-IoT”) communications.

### BRIEF DESCRIPTION OF THE DRAWINGS

For a more complete understanding of the present disclosure, reference now is made to the following description taken in connection with the accompanying drawings.

FIG. 1 is a block diagram of an example of a satellite communications network.

FIG. 2 is a block diagram of an example sequence of system frames for an example communications protocol.

FIG. 3 is a block diagram of an example sequence of system frames, including subframes, for an example communications protocol.

FIGS. 4-5 are block diagrams of example sequences of uplink and downlink system frames for example communications protocols.

FIGS. 6-8 are block diagrams of example sequences of system frames, including subframes, for example communications protocols.

FIG. 9 is a block diagram of example downlink subframes for an example communications protocol.

FIGS. 10-11 are block diagrams of example downlink and uplink subframes for example communications protocols.

FIG. 12 is a block diagram of an example sequence of system frames, including subframes, for an example communications protocol.

FIG. 13 is a block diagram of example subframes for an example communications protocol.

FIG. 14 is a block diagram of example system frames, including subframes, for an example communications protocol.

### DETAILED DESCRIPTION

Narrowband Internet of Things (“NB-IoT”) may generally refer to communications technologies intended to enable wireless communications with large numbers of so-called Internet of Things (“IoT”) communications devices often with a focus on relatively low power, relatively high connection density, and relatively narrow bandwidth. NB-IoT technologies can be deployed for use with both terrestrial and non-terrestrial networks (“NTN”), such as, for example, satellite-based communications networks and high-altitude platform systems (“HAPS”)-based communications networks. In 3GPP Release 18, the 3rd Generation Partnership Project (“3GPP”) specified certain standards for NB-IoT technologies in both terrestrial and NTN networks. More particularly, 3GPP Release 18 sets forth certain specifications (i) for NB-IoT technologies to operate in terrestrial networks in either a half-duplex frequency division duplex (“HD-FDD”) mode, in which paired spectrum is used for downlink and uplink transmissions, respectively, or a time division duplex (“TDD”) mode, in which unpaired spectrum is used for both uplink and downlink transmissions, and (ii) for NB-IoT technologies to operate in NTN networks using an HD-FDD mode.

Deploying NB-IoT using unpaired spectrum for both uplink and downlink transmissions in NTN networks may present challenges due to technical complexities associated with the propagation delays in NTN networks (e.g., due to the relatively long distances between user equipment (“UE”) located on or relatively near the surface of the Earth and HAPS platforms at high altitudes or satellites in orbit (e.g., low-Earth orbit (“LEO”), medium Earth orbit (“MEO”), or geostationary Earth orbit (“GEO”)). Likewise, deploying NB-IoT in NTN networks may present challenges due to limitations on the power available to communications payloads on board HAPS platforms and/or satellites in such NTN networks. For example, limits on the power budgets available to communications payloads on board HAPS platforms and/or satellites in NTN networks may prevent the communications payloads on board such HAPS platforms or satellites from being able to continuously transmit or receive signals in accordance with the NB-IoT HD-FDD mode specified in 3GPP Release 18.

Technologies described in this disclosure, including without limitation systems, techniques, and methods (including methods performed at least in part as a result of executing machine-readable instructions stored on tangible storage media), may enable the deployment of NB-IoT technologies that overcome, fully or partially, one or more of the aforementioned challenges, or aspects thereof, or that otherwise facilitate the deployment of NB-IoT technologies in new or different contexts or environments. For example, technologies described in this disclosure may enable the deployment of NB-IoT using unpaired spectrum for both uplink and downlink transmissions in NTN networks and/or the deployment of NB-IoT in networks in which the radios or other network infrastructure (e.g., communications payloads on board satellites or HAPS platforms in NTN networks) that transmit signals to, and receive signals from, UE are subject to power budgets that may make the continuous transmission and/or reception of signals (e.g., in accordance with the specification for the NB-IoT HD-FDD mode set forth in 3GPP Release 18) difficult or impractical. Additionally or alternatively, technologies described in this disclosure may enable deployment of NB-IoT in a mode that resembles an HD-FDD NB-IoT mode but that uses unpaired spectrum for both uplink and downlink transmissions.

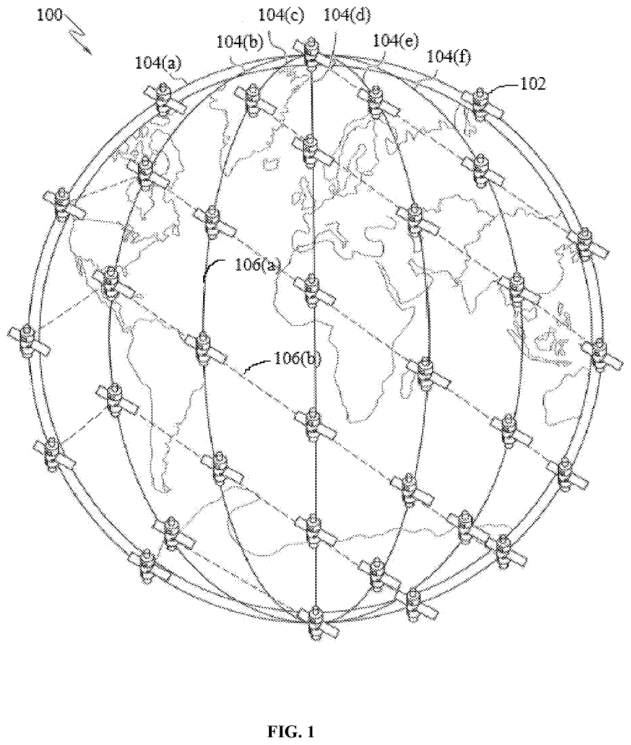

In some implementations, technologies described herein may enable the deployment of NB-IoT technologies in LEO satellite communications networks (or other NTN networks) (i) where communications payloads or other equipment on board satellites of the communications networks are subject to limited power budgets and/or (ii) using unpaired spectrum for both uplink and downlink transmissions, such as, for example, the LEO satellite communications network illustrated in FIG. 1.

As illustrated in FIG. 1, such a LEO satellite communications network 100 may include multiple satellites (e.g., satellite 102) in LEO (e.g., organized in planes 104(a)-104(f) in near-polar orbits). Additionally or alternatively, wireless (e.g., radio frequency (“RF”) or optical) communications links or cross-links (e.g., wireless communications links 106(a) and 106(b)) may be formed between individual satellites of the LEO satellite communications network.

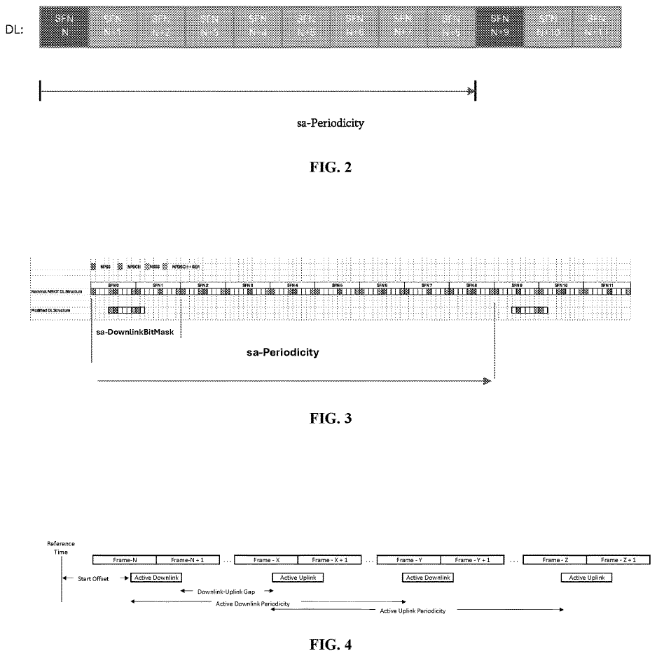

In an NTN system like the LEO satellite communications network illustrated in FIG. 1, satellites and/or HAPS platforms may have on-board batteries that provide power to communications payloads or other equipment on board the satellites or HAPS platforms that enable such communications payloads or other equipment to transmit and receive signals. In such an NTN system, power budgets may limit the per-burst RF energy and/or orbit-average RF energy used to transmit NB-IoT carriers (e.g., anchor carriers and non-anchor carriers). In order to deploy NB-IoT in such an NTN system while staying within such power budgets, an approach that may be referred to as “selective activation” may be employed in which a communications payload or other equipment is configured to transmit during 1 out of N of the system radio frames specified for the NB-IoT HD FDD mode and similarly to receive during 1 out of N of the system frames specified for the NB-IoT HD FDD mode. This parameter may be referred to herein as the selective activation periodicity (“sa-Periodicity”) and it may be measured in system frames. In one particular implementation, an sa-Periodicity of 9 (using a 1:9 activation period for the carrier) may be employed, as illustrated in FIG. 2, but other values also may be used, and, in fact, in some implementations, the sa-Periodicity parameter may be configurable.

In implementations that employ the selective activation technique described above, the UE may need to know and/or the UE may be configured to be able to determine the configuration details of the particular selective activation approach utilized in order to find the anchor carrier. Consequently, the details of the selective activation may not be communicated explicitly in system information (“SI”) messages on the anchor carrier. Rather, alternative techniques may be employed to enable the UE to know and/or determine such configuration details, such as, for example (i) the UE determining the configuration details through measurements/observation; (ii) defining the configuration details as part of the band definition; and/or passing the configuration details to the UE via the Universal Subscriber Identity Module (“USIM”).

In addition, or as an alternative, to employing the selective activation technique described above, in some implementations, the communications payload or other equipment may be configured to limit the number of subframes specified for the NB-IoT HD FDD mode that it transmits per downlink burst. For example, in one implementation in which each system frame is 10 msec in duration and is divided into 10 subframes, each 1 msec in duration, the communications payload or other equipment may be limited to transmitting downlink bursts that are no longer than 8 msec. In such an implementation, the communications payload or other equipment may be configured to not transmit certain subframes specified for the NB-IoT HD FDD mode that do not include System Information (“SI”). For example, the communications payload or other equipment may be configured to not transmit one or more of subframe 1, subframe 2, subframe 3, subframe 6, subframe 7, and subframe 8 specified for the NB-IoT HD FDD mode.

In such implementations, to ensure that a single download burst includes both the Narrowband Primary Synchronization Signal (“NPSS”) and the Narrowband Secondary Synchronization Signal (“NSSS”) specified for the NB-IoT HD FDD mode, the communications payload or other equipment may be configured to transmit download bursts that span two system frames instead of just one system frame. In such an implementation, the communications payload or other equipment may be configured to transmit an information element (“IE”) that may be referred to herein as sa-DownlinkBitMap and that may span two system frames and that may be 20 bits long. In implementations that employ the selective activation technique described above, this sa-DownlinkBitMap IE may be used to communicate to the UE which subframes the UE should ignore (e.g., because the communications payload or other equipment will not be transmitting them) and may be centered with the subframe that has a decodable Narrowband Physical Broadcast Channel (“NPBCH”) (SFO). In one example, the communications payload or other equipment may exclude downlink subframes 1 and 2 from downlink bursts and instead start downlinks bursts with subframe 3. In an alternative example, the communications payload or other equipment may exclude downlink subframes 2 and 3 from downlink bursts and instead start downlink bursts with subframe 4 as illustrated in FIG. 3.

In such an implementation, starting the downlink burst with subframe 4 may allow the UE to detect the NPSS followed by the NSSS within 4 msec. In another example, the communications payload or other equipment may exclude downlink subframes 6 and 7 from downlink bursts and instead start downlink bursts with subframe 8. In such an implementation where a downlink burst starts with subframe 8, the UE may be configured to find the NPSS and then look backwards (e.g., 4 msec) to process the NSSS and/or the UE may be configured to process the NSSS when it receives the next downlink burst under the selective activation technique. In still another example, the communications payload or other equipment may exclude downlink subframes 6-8 from downlink bursts and instead start downlink bursts with subframe 9.

In implementations that employ the selective activation technique and/or in which the communications payload or other equipment is configured to limit the number of subframes specified for the NB-IoT HD FDD mode that it transmits per downlink burst, a UE with knowledge of and/or that is configured to determine the periodicity of the selective activation downlink (sa-Periodicity) and the selective activation downlink invalid subframes (e.g., from the SI message with the sa-DownlinkBitMask), the UE may be configured to search for the NPSS and NSSS and then to receive the NPBCH and the Narrowband Physical Downlink Shared Channel (“NPDSCH”) signals in the anchor carrier.

In some implementations, NB-IoT technologies may be deployed in an NTN network using unpaired spectrum for both uplink and downlink transmissions. For example, in some such implementations, the selective activation technique described above may be employed for both downlink and uplink transmissions. In such implementations, timing offsets may be established between the uplink and downlink selective activation transmissions, for example, that may help to mitigate the propagation delay challenges described above. Notwithstanding the use of the same spectrum for uplink and downlink transmissions, such NB-IoT deployments may be configured to operate in a mode that resembles more of an HD-FDD NB-IoT mode than a TDD NB-IoT mode. Therefore, in such implementations, the band may be identified as “FDD” to signal to the UE to operate in a mode similar to an HD-FDD NB-IoT mode. Additionally or alternatively, a mechanism also may be employed to inform the UE to use the uplink and the downlink in the same frequency band. For example, in some implementations, the communications payload or other equipment may be configured to set the ul-CarrierFreq parameter in the SIB2 transmission accordingly and to instruct the UE to identify different uplink E-UTRA Absolute Radio Frequency Channel Numbers (“EARFCNs”) than specified in the Tx-Rx Frequency Separation as specified in TS 36.101 of 3GPP Release 18.

The NB-IoT frame structure type-1 for use in the NB-IoT HD-FDD mode specified in 3GPP Release 18 is defined as a 10 msec frame divided into 10 subframes, each 1 msec in duration. Some such subframes may be reserved for the transmission of synchronization signals and system broadcast information, such as the Narrowband Primary Synchronization Signal (“NPSS”), Narrowband Secondary Synchronization Signal (“NSSS”), Narrowband Physical Broadcast Channel (“NPBCH”), and System Information Block-1 (SIB-1). Referring to FIG. 4, in implementations that use such NB-IoT frame structure type-1 (or a similar frame structure) to operate in the same frequency band for both uplink and downlink, separate spectrum time may be allocated for each, separated by a time gap. The period during which uplink operations are allowed may be referred to herein as the active uplink, and the period during which downlink operations are allowed may be referred to herein as the active downlink. Depending on the implementation, the duration and periodicity of the active uplink time and the active downlink time may be fixed or configurable and specified in terms of subframes. In either case, however, both the communications payload or other equipment and the UE may be configured so as to not transmit or receive, as appropriate, during inactive uplink or downlink times (which, in some implementations, may be set to account for propagation delays), resulting in discontinuous downlink and uplink transmissions.

In such implementations, multiple techniques may be employed to inform the UE of the start time, duration, and/or periodicity of the uplink active and downlink active times, and the time gap between them. Examples of such techniques are described further below as are examples of changes to the scheduling of different channels that may be employed in certain implementations.

In some implementations, the active time periodicity may be configured to be in multiples of 10 msec. Additionally or alternatively, the start offset and duration of downlink active time may be set to provide adequate opportunities for UEs to receive NPSS, NSSS, and NPBCH, and to achieve downlink synchronization without prior knowledge of discontinuous downlink transmission. In some particular implementations, the start offset is set such that NPSS and NPBCH may be transmitted in every active downlink time, while NSSS may be transmitted in every other active downlink time. Additionally or alternatively, in some implementations, the scheduling of NPSS, NSSS, and NPBCH may be set to follow the same schedule as in the NB-IoT HD-FDD mode specified in 3GPP Release 18 except that, as described above, downlink transmissions may be set to occur only during active downlink times and may be disabled during inactive downlink times.

In some implementations, SIB-1 scheduling parameters may be set to provide multiple subframes carrying SIB-1 within the downlink active times to increase the likelihood of reception of an adequate number of subframes carrying SIB-1 by the UE and, thereby, enable the UE to quickly receive SIB-1. For example, in particular implementations, the scheduling parameter may be set to allow a subframe carrying SIB-1 in every other downlink active time. Additionally or alternatively, the scheduling of SIB-1 may be set to follow the same schedule as in the NB-IoT HD-FDD mode specified in 3GPP Release 18 except that, as described above, downlink transmissions may be set to occur only during active downlink times and may be disabled during inactive times.

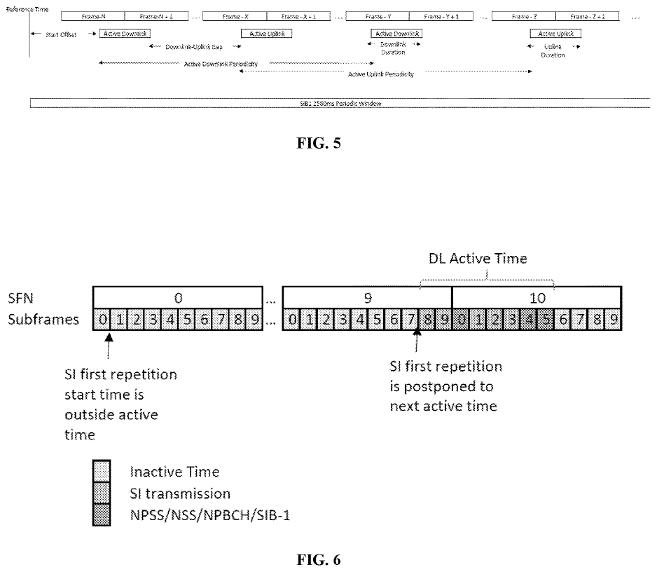

As mentioned above, implementations may employ multiple different techniques to inform the UE about parameters related to the uplink and downlink active times described above. In one example implementation, the ASN.1 content of SIB-1 and/or SIB-2 may be set to include Information Elements (“IE”) that convey the parameters described below with reference to FIG. 5:
Active Downlink Periodicity: The periodicity of the active downlink time in 10 msec radio frames. In some specific implementations, this may be set to N=9 (e.g., one active downlink time every 90 msec).
Active Uplink Periodicity: The periodicity of the active uplink time in 10 msec radio frames. In some specific implementations, this may be set to N=9 (e.g., one active downlink time every 90 msec).
Downlink Duration: The duration of active downlink time in number of subframes. In some specific implementations, this may be set to D=8 (e.g., 8 1 msec subframes or 8 msec).
Uplink Duration: The duration of active uplink time in number of subframes. In some specific implementations, this may be set to U=8 (e.g., 8 1 msec subframes or 8 msec).
Downlink-Uplink Gap: The time gap between the active downlink and active uplink time in number of subframes. In some specific implementations, this may be set to 50 subframes or 50 msec.
Start Offset: The offset in subframes from the start of the radio frame at the beginning of a fixed 2560 msec SystemInformationType1-NB scheduling period to the start of the first active downlink time. Communicating this parameter to the UE may enable the UE to map the frame structure into defined NB-IoT System Frame Number (SFN): Subframe Number (SF) timing based on a message that is received on a known SFN SF. In some specific implementations, this parameter may be communicated in SIB-1. SIB-1 may be re-encoded every 2560 msec scheduling period. Including this parameter in SIB-1 may allow a new value of the Start Offset parameter to be communicated to the UE to reflect relative movement between the Active Downlink Periodicity period and the SIB-1 scheduling period. Additionally or alternatively, communicating this parameter in SIB-1 may allow problems associated with SFN wrap to be avoided or mitigated. In implementations in which the Downlink Duration is less than 10 subframes and the start of the subframes within the active downlink time is already known to the UE, this parameter may be unnecessary.
   In this example implementation, all uplink-specific parameters may be communicated to the UE in SIB-2. Additionally or alternatively, not all of the above parameters may be transmitted to the UE in SIB-1 or SIB-2 as the UE may be configured to detect or infer the values of one or more such parameters depending on the values set for Downlink Duration, Downlink Periodicity, etc. For example, the UE may be able to detect the periodicity of the active downlink time in 10 msec radio frames using the NPSS in implementations where the NPSS is present in every downlink active time.

In some implementations, the parameters related to the uplink and downlink active times described above may be conveyed in SIB-1 and SIB-2 ASN.1 in a different format, such as, for example, a bitmap of a length equal to the periodicity of the active downlink time. In a second example implementation, if the allowed active time periodicity is 70 msec or 90 msec, the definition of the IE downlinkBitmap-r13 may be expanded by adding the below IE in SIB-1:

DL-Bitmap-NB-rXX ::= CHOICE {
subframePattern70-rXX BIT STRING (SIZE (70)),
subframePattern90-rXX BIT STRING (SIZE (90))
}

Additionally or alternatively, for the uplink, the below bitmap IE may be added either in the SIB-1 or SIB-2:

UL-Bitmap-NB-rXX ::= CHOICE {
subframePattern70-rXX BIT STRING (SIZE (70)),
subframePattern90-rXX BIT STRING (SIZE (90))
}

In such bitmaps, the first/leftmost bit may correspond to the subframe 0 of the radio frame carrying the first repetition of the SIB-1 in a fixed 2560 ms period, the presence of the Value 0 in the bitmap may indicate that the corresponding subframe is invalid for transmission, and the presence of the Value 1 in the bitmap may indicate that the corresponding subframe is valid for transmission.

In a third example implementation, the parameters related to the uplink and downlink active times described above may be set in the definition of a band. If a UE is camped in a single cell in such a band, it may assume a configured fixed value for all or some of these parameters.

In some implementations, System Information (“SI”) scheduling is set to accommodate discontinuous active downlink time. In such implementations, SI messages may be transmitted within periodically occurring time domain windows, which may be referred to herein as SI-windows, based on scheduling information provided in SIB-1. Each SI message may be associated with a SI-window, and the SI-windows of different SI messages may not overlap. For example, within one SI-window, only the corresponding SI may be transmitted. The length of the SI-window may be common for all SI messages and it also may be configurable. Within an SI-window, the corresponding SI message may be transmitted several times over 2 or 8 consecutive NB-IoT downlink subframes, for example, depending on the transport block size (“TBS”). For example, in some implementations, if the TBS is 208 bits or more, 8 consecutive NB-IoT downlink subframes may be used to transmit the SI message.

In some implementations, if the scheduled transmission of an SI message falls within an inactive downlink time, the communications payload or other equipment may postpone the transmission of the SI message to the next active downlink time within a single SI window, for example, as illustrated in FIG. 6, in which the downlink burst is configured to begin with subframe 8.

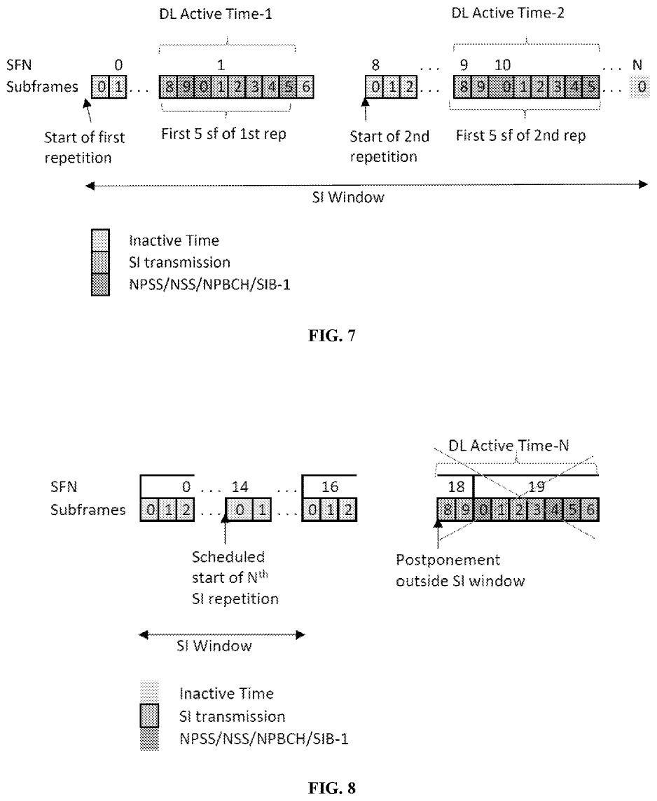

In some cases, postponing the transmission of an SI message to the next active downlink time as described above may result in an overlap of the postponed SI message with the next scheduled repetition of the SI message within the SI-window. Therefore, in some implementations, transmission of any postponed SI message may be truncated if the postponed SI message will overlap with the next scheduled repetition of the SI message. For example, as illustrated in FIG. 7, in which the downlink burst again is configured to begin with subframe 8 and where the SI message is scheduled for repetition pattern every 8th system frame, the transmission of the postponed SI message may be truncated at subframe 8 because that is where the start of the next repetition of the SI message is scheduled. Thus, in the example illustrated in FIG. 7, the second downlink active time carries subframes from the second repetition of the SI message instead of the last three subframes of the postponed SI message.

Additionally or alternatively, in some cases, postponing the transmission of an SI message to the next active downlink time as described above may result in the SI message being scheduled for transmission in subframes outside of the configured SI-window for the SI message. In some implementations, in such cases, the SI message may be truncated to avoid transmission of the SI message outside the configured SI-window for the message as illustrated in FIG. 8, in which the downlink burst again is configured to begin with subframe 8.

In some implementations, after active downlink time has been allocated for the transmission of NPSS, NSSS, NPBCH, SIB-1, and/or SI messages, for example, in accordance with one or more of the techniques described above, remaining active downlink time may be allocated to an eNodeB for the network to schedule signaling and UE- or user-specific data on Narrowband Physical Downlink Control Channel (“NPDCCH”) and/or Narrowband Physical Downlink Shared Channel (“NPDSCH”) for different UEs.

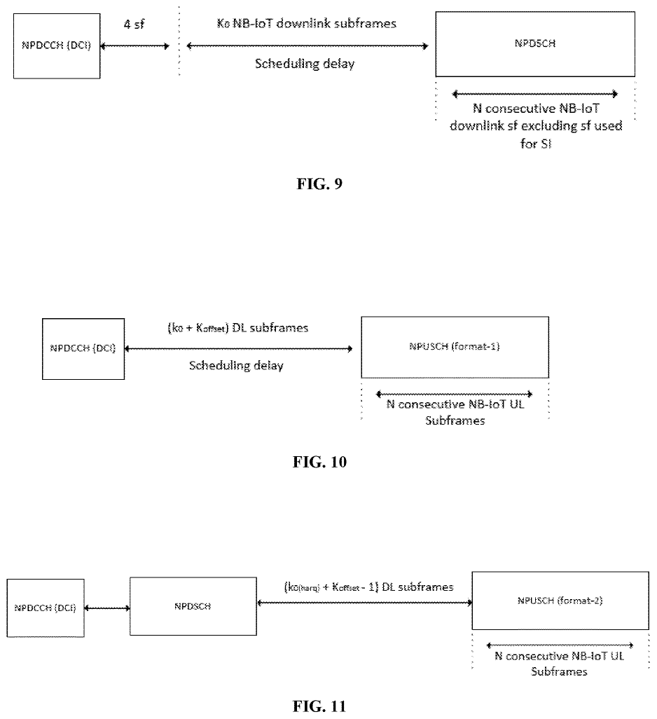

The NB-IoT HD-FDD mode specified in 3GPP Release 18 uses the concept of so-called “NB-IoT downlink subframes” (TS 36.213 § 16.4), which are defined to exclude subframes set to be used for NPSS, NSS, NPBCH, and SIB-1 transmissions as well as subframes that are not marked as valid for transmission in the SIB-1 optional IE called downlinkBitmap-r13, to schedule NPDCCH and NPDSCH transmissions. This may avoid the transmission of NPDCCH and NPDSCH in downlink subframes set to be used for NPSS, NSS, NPBCH, and SIB-1 transmissions. In the NB-IoT HD-FDD mode specified in 3GPP Release 18, NPDCCH and NPDSCH transmissions are scheduled to be transmitted in the next valid NB-IoT downlink subframes that are not scheduled for SI messages. For some implementations, to accommodate the discontinuous downlink transmission techniques described above, the definition of the NB-IoT downlink subframe set forth above may be modified such that NB-IoT downlink subframes also correspond to active downlink times. In such implementations, NPDCCH and NPDSCH may not be transmitted in subframes set for transmitting SI messages and instead may be postponed until the next valid NB-IoT downlink subframe, for example, as illustrated in FIG. 9.

Similarly, the NB-IoT HD-FDD mode specified in 3GPP Release 18 uses the concept of so-called “NB-IoT uplink subframes” to schedule Narrowband Physical Uplink Shared Channel (“NPUSCH”) uplink transmissions by a UE across “consecutive NB-IoT uplink slots” (36.213 § 16.5.1) and (36.213 § 16.5). For some implementations, to accommodate the discontinuous uplink transmission techniques described above, the definition of NB-IoT uplink subframes specified in 3GPP Release 18 may be modified so that NB-IoT uplink subframes also correspond to active uplink times. In such implementations, the start of any NPUSCH transmission that is scheduled to begin transmission by a UE during an inactive uplink time may be postponed until the next active uplink time, for example, as illustrated in FIG. 10.

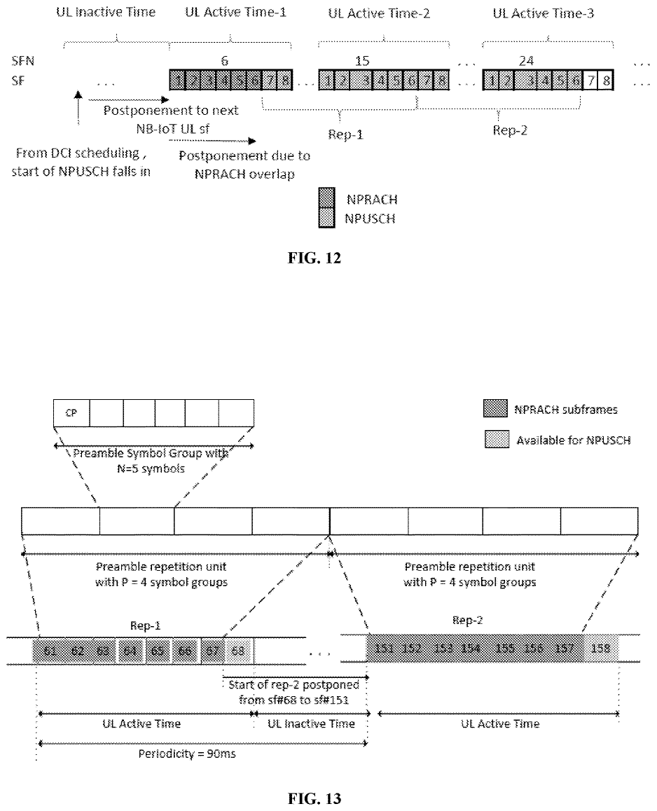

In implementations in which the definition of NB-IoT uplink subframes is modified to exclude inactive uplink subframes as described above, the start of an NPUSCH transmission may be postponed to the next uplink active time if the NPUSCH transmission originally is scheduled to begin during an inactive uplink subframe. In such implementations, the NPUSCH transmission may be completed over the course of one or more consecutive uplink active times. For example, in implementations that employ subcarrier spacing of 15 kHz, an NPUSCH resource unit (“RU”) may fit within a single uplink active time opportunity. However, in implementations that employ subcarrier spacing of 3.75 kHz, an NPUSCH RU may be split across multiple uplink active time opportunities. In some cases, even in implementations that employ subcarrier spacing of 15 kHz, an NPUSCH RU may be split across multiple uplink active time opportunities, for example, due to DCI scheduling and/or due to NPRACH postponement as illustrated in FIG. 12 (e.g., where RU=8 msec, repetition=2, and downlink duration=8 subframes).

In some implementations, each slot carrying NPUSCH may include one or three symbols of DMRS. Thus, in such implementations, it may be possible to split NPUSCH transmissions with a total duration of greater than 8 msec across multiple uplink active time opportunities, as each transmission may be self-contained and equalized independently.

In some implementations, the techniques for scheduling NB-IoT Narrowband Physical Random Access Channel (“NPRACH”) uplink transmissions specified in 3GPP Release 18 may be employed for scheduling NPRACH transmissions by the UE except that any NPRACH transmission scheduled to be transmitted during an inactive uplink time may be postponed until the next active uplink time.

In some implementations, a preamble repetition unit of an NPRACH transmission may be of duration 5.6 msec for NPRACH format 0 or duration 6.4 msec for NPRACH format 1, both of which may fit in in a single uplink active time opportunity (e.g., when the UplinkDuration parameter is equal to or greater than 8 msec). Additionally or alternatively, a symbol group may include a cyclic prefix and a sequence of 5 identical symbols. In some implementations, the total number of symbol groups in a preamble repetition unit of an NPRACH transmission may be denoted by P=4, and this preamble repetition unit of P=4 may be repeated a power of 2 times up to 128. However, in implementations that employ the selective activation technique for uplink transmissions described above, more than one preamble repetition unit may not fit within one uplink active time opportunity. Therefore, in such implementations, NPRACH preamble repetition units may be transmitted whole and in consecutive uplink active times as illustrated in FIG. 13.

For example, a format 1 preamble repetition unit to be repeated 2 times (e.g., for a total duration 12.8 ms) may be transmitted once during opportunity 1 and repeated again in opportunity 2, which may increase the likelihood of successful decoding by the receiver.

In some implementations, the transmission of a postponed NPRACH preamble repetition unit is truncated if the postponed NPRACH repetition unit transmission overlaps with the next NPRACH opportunity. In such implementations that also employ the selective activation technique for uplink transmissions described above, uplink inactive times may be excluded from NPRACH opportunities, and postponed NPRACH repetition unit transmissions may be scheduled for the next NRPACH opportunity that falls within an uplink active time.

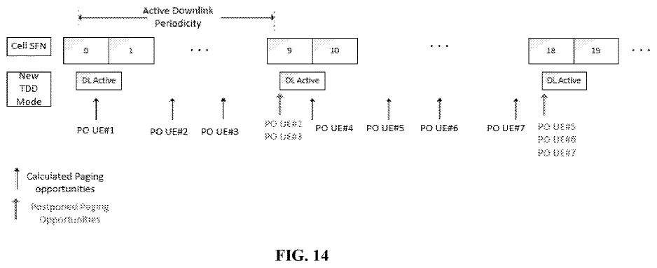

In some implementations, UE paging is specified to occur in certain dedicated frames and subframes. The frames where paging is specified to occur may be referred to as Paging Frames (“PF”), and the subframes where paging is specified to occur within these Paging Frames may be referred to as Paging Occasions (“PO”). Additionally or alternatively, the NPDCCH with DCI format N2 may be carried in the PO. An individual UE may be assigned to a specific Paging Frame based on the UE's International Mobile Subscriber Identity (“IMSI”) value. Once so assigned, the UE may be configured to monitor only one Paging Occasion per discontinuous reception (“DRX”) cycle. In some implementations, the subframes that can be used for Paging Occasions may be restricted by the number of POs per frame, and, in one example, the allowed subframes may be subframe 0, subframe 4, subframe 5, and subframe 9. In such implementations that also employ the selective activation technique for downlink transmissions described above, the paging subframes available to carry Paging Occasions and their corresponding paging messages may occur in the Downlink Duration subframes every Active Downlink Periodicity. Additionally or alternatively, the Paging Frame and associated Paging Opportunity initially calculated for a UE based on its IMSI value may fall within a downlink inactive time. When this happens, the Paging Opportunity for the UE may be postponed until the next downlink active time, for example, as illustrated in FIG. 14 for the case where Downlink Duration=8 subframes and Active Downlink Periodicity=90 msec.

As illustrated in FIG. 14, all of the paging opportunities within the 90 msec active downlink period have been compressed into the 8 msec downlink active time.

In some implementations in which paging may be performed in extended discontinuous reception (“e-DRX”), a UE may be configured to calculate the Paging Hyper Frame (“PH”) and Paging Transmit Window (“PTW”) in accordance with 3GPP Release 18. In such implementations, the PTW duration, specified in seconds, may accommodate multiple downlink active time opportunities. In such implementations, if a Paging Opportunity within a PTW for a UE falls during a downlink inactive time, it may be postponed until the next downlink active time.

As described herein, a UE may be any form of communications device, including, for example, a transceiver, a modem, a module, a chip or chipset, or a communications terminal.

Aspects of the present disclosure may be implemented entirely in hardware, entirely in software (including firmware, resident software, micro-code, etc.) or in combinations of software and hardware. Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of such a computer-readable storage medium include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, radio frequency (“RF”) signals, etc., or any suitable combination of the foregoing.

Computer program code for carrying out operations for aspects of the present disclosure may be written in any combination of one or more programming languages, including object oriented programming languages, dynamic programming languages, and/or procedural programming languages.

The techniques, functionality, and operations described herein represent examples of various aspects of the present disclosure. In this regard, it should be noted that, in some alternative implementations, functions and process steps may be performed in different orders than as described herein. For example, two process steps described herein as being performed in succession may, in fact, be executed substantially concurrently, or the process steps may be executed in the reverse or other order from that described herein, depending upon the functionality involved. It will also be noted that the different techniques, functions, operations, and/or process steps can be implemented by special purpose hardware-based systems that perform the specified techniques, functions, operations, and/or process steps, or combinations of special purpose hardware and computer instructions.

While many of the techniques disclosed herein are described largely in the context of NTN networks, such as, for example, satellite communications networks and HAPS-based communications networks, and, in some cases, particularly LEO satellite communications networks, such techniques may be employed in any of a variety of NTN networks, terrestrial networks, or combinations thereof.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise.

The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to explain the principles of the disclosure and the practical application, and to enable others of ordinary skill in the art to understand the disclosure with various modifications as are suited to the particular use contemplated.

What is claimed:

1. A method for enabling uplink and downlink wireless communications between user equipment and a communications payload in an unpaired frequency band using a protocol that employs defined system frames, the method comprising:
determining, by the user equipment, an uplink periodicity at which the communications payload expects to receive uplink transmissions in the unpaired frequency band from the user equipment, the uplink periodicity being expressible as a ratio of 1/N, where N represents a number of system frames; and
transmitting, by the user equipment, uplink transmissions in the unpaired frequency band to the communications payload at the determined uplink periodicity.

2. The method of claim 1, wherein:
determining, by the user equipment, an uplink periodicity at which the communications payload expects to receive uplink transmissions in the unpaired frequency band from the user equipment includes determining, by the user equipment, an uplink periodicity of
$$\frac{1}{9 system frames} ;$$
and transmitting, by the user equipment, uplink transmissions in the unpaired frequency band to the communications payload at the determined uplink periodicity includes transmitting, by the user equipment, uplink transmissions in the unpaired frequency band to the communications payload at an uplink periodicity of
$$\frac{1}{9 system frames} .$$

3. The method of claim 1 wherein transmitting, by the user equipment, uplink transmissions in the unpaired frequency band to the communications payload at the determined uplink periodicity includes not transmitting uplink transmissions in the unpaired frequency band to the communications payload outside of the uplink periodicity.

4. The method of claim 1, wherein:
each system frame is defined to include a number of subframes; and
transmitting, by the user equipment, uplink transmissions in the unpaired frequency band to the communications payload at the determined uplink periodicity includes transmitting, by the user equipment, uplink transmissions in the unpaired frequency band to the communications payload during active uplink periods at the determined uplink periodicity that include fewer subframes than the number of subframes defined for each system frame.

5. The method of claim 4, wherein transmitting uplink transmissions in the unpaired frequency band to the communications payload during active uplink periods at the determined uplink periodicity that include fewer subframes than the number of subframes defined for each system frame includes transmitting uplink transmissions in the unpaired frequency band to the communications payload during active uplink periods at the determined uplink periodicity that span two system frames.

6. The method of claim 1 further comprising:
determining, by the user equipment, a downlink periodicity at which the communications payload is configured to transmit downlink transmissions in the same unpaired frequency band to the user equipment, the downlink periodicity being expressible as a ratio of 1/M, where M represents a number of system frames; and
preparing, by the user equipment, to receive downlink transmissions in the same unpaired frequency band from the communications payload at the determined downlink periodicity.

7. The method of claim 6, wherein N=M.

8. The method of claim 1, wherein determining, by the user equipment, an uplink periodicity at which the communications payload expects to receive uplink transmissions in the unpaired frequency band from the user equipment includes determining the uplink periodicity based on information stored in a Universal Subscriber Identity Module assigned to the user equipment.

9. The method of claim 1, wherein determining, by the user equipment, an uplink periodicity at which the communications payload expects to receive uplink transmissions in the unpaired frequency band from the user equipment includes:
receiving a downlink transmission in the unpaired frequency band from the communications payload; and
determining the uplink periodicity based on the received downlink transmission from the communications payload.

10. The method of claim 1, wherein the communications payload is a communications payload on a satellite in orbit.

11. The method of claim 1, wherein the communications payload is a communications payload on a high-altitude platform system.

12. The method of claim 1, wherein the communications payload is a component of a terrestrial communications network.

13. User equipment for communicating wirelessly with one or more communications payloads in an unpaired frequency band using a protocol that employs defined system frames, the user equipment comprising:
one or more processing elements; and
non-transitory computer-readable storage media storing instructions that, when executed by the one or more processing elements, cause the one or more processing elements to:
determine an uplink periodicity at which the communications payload expects to receive uplink transmissions in the unpaired frequency band from the user equipment, the uplink periodicity being expressible as a ratio of 1/N, where N represents a number of system frames; and
transmit uplink transmissions in the unpaired frequency band to the communications payload at the determined uplink periodicity.

14. The user equipment of claim 13, wherein the user equipment is a transceiver.

15. The user equipment of claim 13, wherein the user equipment is a modem.

16. The user equipment of claim 13, wherein the user equipment is a module.

17. The user equipment of claim 13, wherein the user equipment is a chip.

18. The user equipment of claim 13, wherein the user equipment is a chipset.

19. The user equipment of claim 13, wherein the user equipment is a communications terminal.

20. A non-transitory, computer-readable storage medium storing instructions for enabling wireless communications between user equipment and a communications payload in an unpaired frequency band using a protocol that employs defined system frames that, when executed by one or more processing elements, cause the one or more processing elements to:
determine an uplink periodicity at which the communications payload expects to receive uplink transmissions in the unpaired frequency band from the user equipment, the uplink periodicity being expressible as a ratio of 1/N, where N represents a number of system frames; and
transmit, from the user equipment, uplink transmissions in the unpaired frequency band to the communications payload at the determined uplink periodicity.
